(19) United States
(12) Patent Application Publication
(10) Pub. No.: US 2006/0253411 A1
(43) Pub. Date: Nov. 9, 2006

(54) Method, system and program product for inserting visual controls for data values in web content from a legacy web application without rewriting the legacy web application

(75) Inventors: Amber Roy-Chowdhury, Cary, NC (US); Marshall A. Lamb, Raleigh, NC (US); Shankar Ramaswamy, Chapel Hill, NC (US); Xinyi Xu, Morrisville, NC (US)

Correspondence Address: HOFFMAN, WARNICK & D'ALESSANDRO LLC, 75 STATE ST, 14TH FLOOR, ALBANY, NY, 12207, US

(73) Assignee: International Business Machines Corporation, Armonk, NY (US)

(21) Appl. No.: 11/122,900

(22) Filed: May 5, 2005

(51) Int. Cl. G06F 17/30; G06F 7/00

(52) U.S. Cl. 707/1

(57) ABSTRACT

Under the present invention, a request for web content is received from a user in a proxy portlet of a portal server. In response, the proxy portlet will obtain markup for the web content from the appropriate web application(s). Upon receipt, metadata corresponding to the markup will be analyzed to identify a set of (e.g., one or more) data values in the markup, as well as locations in the markup for inserting visual controls for the set of data values. Thereafter, additional markup for the visual controls will be generated and inserted into the markup for the web content at the identified locations without rewriting the web application(s). The portal page will then be aggregated and served to the end user.

### CROSS-REFERENCE TO RELATED APPLICATIONS

This application is related in some aspects to commonly assigned U.S. application Ser. No. 10/292,974 filed Nov. 12, 2002 and entitled “Portlet Data Sharing Method, System and Program Product,” to commonly assigned U.S. application Ser. No. 10/448,968 filed May 30, 2003 and entitled “System and Method for User Driven Interactive Application Integration,” and to commonly assigned U.S. application Ser. No. 10/776,040 filed Feb. 11, 2004 and entitled “Persistence of Inter-Application Communication Patterns and Behavior Under User Control,” each of which is hereby incorporated by reference.

### BACKGROUND OF THE INVENTION

1. Field of the Invention

The present invention generally relates to portal technology. Specifically, the present invention provides a method, system and program product for inserting visual controls into markup for data values in corresponding web content without rewriting the web applications from which the web content is obtained.

2. Related Art

Web portals are a relatively new technology that is used to realize web sites, which are single points of content aggregation and information access. In one embodiment, a single portal page can include multiple portlets that each input/import data from its own “legacy” web application. In general, a portal page is generated and served to an end user from a portal server. The portal server will typically include a portal program such as WebSphere Portal Server, which is commercially available from International Business Machines Corp. of Armonk, N.Y. One role that can be played by the portal program is to coordinate with the outside web applications to obtain requested web content, aggregate the same, and serve the resulting portal pages to the end users.

In many cases, customers purchasing portal technology already have a large existing investment in web applications that run on existing web application servers. The standard before the present invention has been to rewrite such web applications as portlets (e.g., applications suitable for aggregation by a portal server). While rewriting such legacy web applications can result in tight integration of these applications into a portal, and also for leveraging the various value-added services which portals offer, rewriting is often not feasible due to the extremely time consuming and costly nature of the rewriting process.

Heretofore, attempts to alleviate the rewriting of web applications were realized through proxy portlets in which content generated by the web applications were brought into a portal through a proxy portlet. Although proxy-based solutions allow web applications to be rapidly aggregated on web pages, they cannot leverage a key value-added service provided by portals, which is cross-portlet communication. Specifically, it is often the case that the web applications being proxied and placed on the same page may be related to executing a single task. That is, data values used by one portlet could be of use to one or more other portlets on the portal page. With current proxy-based approaches, the end users interacting with the portlets are required to manually enter information from one portlet into another portlet. If such manual steps could be eliminated, simplified, or automated, the user experience would be enhanced, and more scenarios involving existing web applications could be brought into portals with greater enhancements to usability and productivity.

### SUMMARY OF THE INVENTION

In general, the present invention provides a method, system and program product for inserting visual controls for data values in web content from legacy web applications without rewriting the legacy web applications. Specifically, the present invention provides a way for data values to be used by multiple portlets without requiring manual inputting by the end user, or rewriting of web applications from which the data values are received. Under the present invention, a request for web content is received from a user in a proxy portlet of a portal server. In response, the proxy portlet will obtain markup for the web content from the appropriate web application(s). Upon receipt, metadata corresponding to the markup will be analyzed to identify a set of (e.g., one or more) data values in the markup, as well as locations in the markup for inserting visual controls for the set of data values. Thereafter, additional markup for the visual controls will be generated and inserted into the markup for the web content at the identified locations. The portal page will then be aggregated and served to the end user. Each of the visual controls is associated with a set of actions that can be selected by the end user. Accordingly, if a visual control is activated by the end user, a set of possible actions for the corresponding data value will be displayed for selection by the end user. All of this occurs without having to rewrite the web application.

A first aspect of the present invention provides a method for inserting visual controls for data values in web content, comprising: receiving markup pursuant to a request for web content; analyzing metadata corresponding to the markup to identify a set of data values in the web content and a set of locations in the markup to insert a set of visual controls for the set of data values; generating additional markup for the set of visual controls; and inserting the additional markup into the markup at the set of locations identified during the analyzing step.

A second aspect of the present invention provides a method for inserting visual controls for data values in web content, comprising: receiving markup in a proxy portlet on a portal server from a web application pursuant to a request for web content received in the proxy portlet from a portal client; analyzing metadata corresponding to the markup to identify a set of data values in the web content that can be used by multiple portlets and a set of locations in the markup to insert a set of visual controls for the set of data values, wherein each of the set of visual controls is associated with a set of actions; generating additional markup for the set of visual controls; and inserting the additional markup into the markup at the set of locations identified during the analyzing step.

A third aspect of the present invention provides a system for inserting visual controls for data values in web content, comprising: means for receiving markup pursuant to a request for web content; means for analyzing metadata corresponding to the markup to identify a set of data values in the web content and a set of locations in the markup to insert a set of visual controls for the set of data values; means for generating additional markup for the set of visual controls; and means for inserting the additional markup into the markup at the set of locations.

A fourth aspect of the present invention provides a program product stored on a recordable medium for inserting visual controls for data values in web content, the recordable medium comprising program code for performing the following steps: receiving markup pursuant to a request for web content; analyzing metadata corresponding to the markup to identify a set of data values in the web content and a set of locations in the markup to insert a set of visual controls for the set of data values; generating additional markup for the set of visual controls; and inserting the additional markup into the markup at the set of locations identified during the analyzing step.

A fifth aspect of the present invention provides a method for deploying an application for inserting visual controls for data values in web content, comprising: providing a computer infrastructure being operable to: receive markup pursuant to a request for web content; analyze metadata corresponding to the markup to identify a set of data values in the web content and a set of locations in the markup to insert a set of visual controls for the set of data values; generate additional markup for the set of visual controls; and insert the additional markup into the markup at the set of locations.

A sixth aspect of the present invention provides computer software embodied as a propagated signal for inserting visual controls for data values in web content, the computer software comprising instructions to enable a computer system to perform the following functions: receive markup pursuant to a request for web content; analyze metadata corresponding to the markup to identify a set of data values in the web content and a set of locations in the markup to insert a set of visual controls for the set of data values; generate additional markup for the set of visual controls; and insert the additional markup into the markup at the set of locations.

Therefore, the present invention provides a method, system and program product for inserting visual controls for data values in web content.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 depicts a proxy portlet methodology according to the prior art.

FIG. 2 depicts an illustrative system for inserting visual controls for data items in web content according to the present invention.

FIG. 3 depicts a more detailed computerized implementation according to the present invention

FIG. 4 depicts a method flow diagram according to the present invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE DRAWINGS

As indicated above, the present invention provides a method, system and program product for inserting visual controls for data values in web content. Specifically, the present invention provides a way for data values to be used by multiple portlets without requiring manual inputting by the end user, or rewriting of web applications from which the data values are received. Under the present invention, a request for web content is received from a user in a proxy portlet of a portal server. In response, the proxy portlet will obtain markup for the web content from the appropriate web application(s). Upon receipt, metadata corresponding to the markup will be analyzed to identify a set of (e.g., one or more) data values in the markup, as well as locations in the markup for inserting visual controls for the set of data values. Thereafter, additional markup for the visual controls will be generated and inserted into the markup for the web content at the identified locations. The portal page will then be aggregated and served to the end user. Each of the visual controls is associated with a set of actions that can be selected by the end user. Accordingly, if a visual control is activated by the end user, a set of possible actions for the corresponding data value will be displayed for selection by the end user.

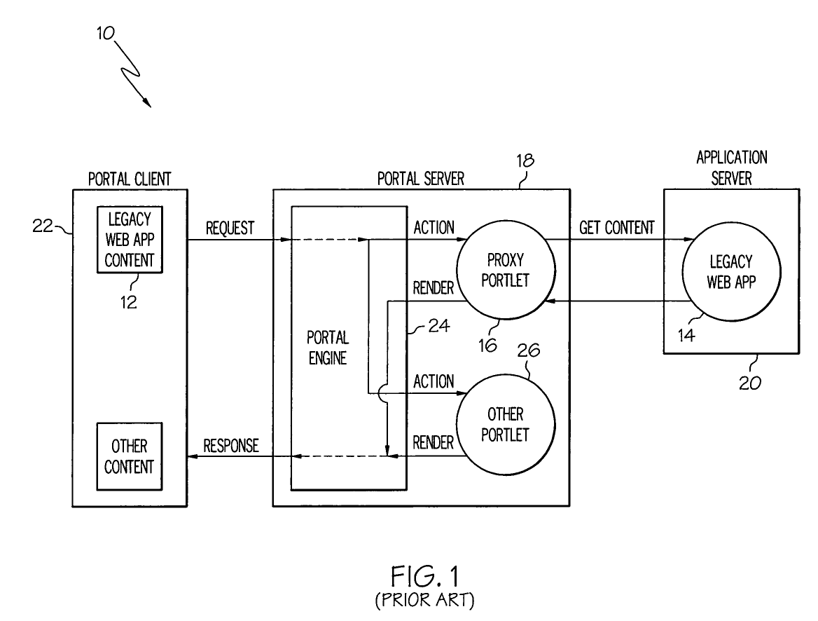

Referring now to FIG. 1, a proxy portlet system 10 according to the prior art is shown. Specifically, system 10 indicates how content 12 for a legacy web application 14 is brought into a portal through a proxy portlet 16. Assume in an illustrative example that portal server 18 comprise WebSphere Portal Server. In WebSphere Portal server, proxy portlet 16 may be an instance of the Web Clipper portlet. In such an instance, a portlet called the Web Clipping Editor may be used to generate instances of web clippers. Each instance is parameterized with the Uniform Resource Locator (URL) information for accessing the legacy web application 14 shown loaded on application server 20. Hypertext Transfer Protocol (HTTP) is used as the communication protocol between a browser on the portal client and portal server 18, as well as between proxy portlet 16 and legacy web application 14. Proxy portlet 16 rewrites URLs in the markup returned by the legacy web application 14 so that the rewritten URLs “point” back to the proxy portlet 16. Thus, when a user selects (e.g., “clicks”) on links in the rewritten markup, the request goes through the portal server 18. The proxy portlet 16 then maps the rewritten URL to the original URL and invokes the legacy web application 14 to obtain the markup for the next page. Also shown on portal server are portal engine 24 and “other portlets” 26. These components typically facilitate the handling of requests from portal client 22, the aggregation of requested web/portal content into portal page, and the delivery of the portal page to portal client.

Portal servers (e.g. portal server 18) generally process requests in two phases. In the first phase, called the event phase, an action may be delivered on a portlet if so specified through the link which was used to initiate the request. In the second phase, called the render phase, markup is collected from each portlet on the page, aggregated with markup generated by the portal server itself, and the entire page returned to the portal client 22 (via a browser). Unfortunately, as mentioned above, proxy portlets models such as system 10 fail to provide a way for portlets to communicate with one another without requiring any rewriting of legacy web applications. Specifically, it could be the case that one portlet will import web content from a legacy web application that contains data values, which can also be used by another portlet on the page. This is especially likely since it is common for portlets on a single portal page to be related to one another. For example, a single portal page for a retail company could have portlets for inventory management, order processing, accounting, etc. Each of these portlets might be able to use “order number” data values to provide some form of output to a user. However, prior to the present invention, the communication of such data values between portlets was not feasible without rewriting the legacy web applications.

Under the present invention, a list of pointers is placed into the markup generated by the legacy web applications. The pointers identify the spots in the markup that are associated with the data values that can (or are to) be communicated to other portlets. Each such list would be associated with a page or a set of pages returned by a web application, based on URL pattern matching. In typical embodiment, the XML Path Language (XPATH) standard is used to identify precise locations for inserting visual controls on a web page. This typically involves verifying that the markup returned from the legacy web application is XHTML compliant. If this is not already true, an HTML to XHTML converter can be used to rectify the markup.

Additional metadata associated with the markup will be stored to provide information about the markup and data value(s) to be communicated. For example, such metadata may specify a type associated with the data value that could be used to determine the appropriate targets to which the data value could be communicated. A visual control would be inserted at the place in the markup pointed to by each XPATH expression, which would allow the end-user to view the possible interactions that could be initiated for the data value and to trigger such interactions. The list of possible interactions would be computed dynamically by the portal runtime by using the metadata associated with the data value (such as its type), and knowledge of the currently active target portlets.

Some of the advantages provided by the present include the following:

1. The ability to insert visual controls in markup generated by a legacy web application, without requiring the legacy application to be modified.

2. The ability to locate the visual controls in precise points in the markup, relative to the data values with which they are associated. For example, a control for transmitting a trouble ticket could be inserted just after the point where the trouble ticket is rendered. A control for initiating a chat or viewing an employee record could be inserted just after the point where the employee name is rendered.

3. The ability to enable legacy web applications to exchange data with other applications in a portal environment, without any modifications to the legacy application.

It should be understood that the present invention may be implemented on top of existing portal frameworks and applications such as web clipping portlets. One possible implementation includes using WebSphere Portal Server as the portal framework and the Web Clipper provided with WebSphere Portal Server as the means for surfacing markup from legacy web applications through portlets.

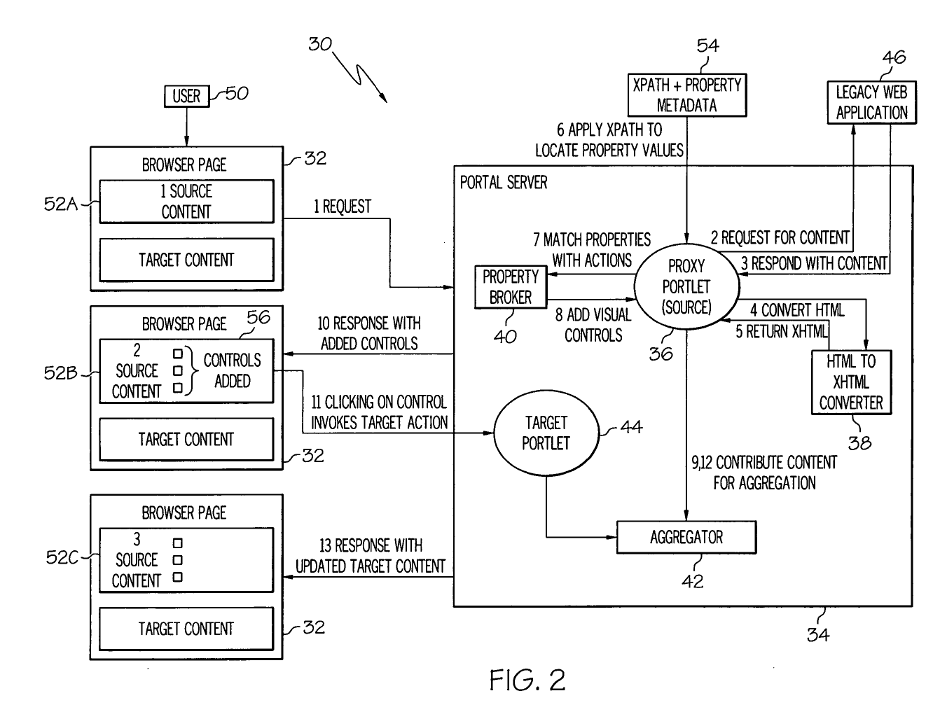

Referring now to FIG. 2, a system 30 for inserting visual controls for data values in web content according to the present invention is shown. As depicted, system 30 depicts a portal client 32 (at three different states), portal server 34, and legacy web application (hereinafter web application 46 that is typically implemented on an application server that is not shown in FIG. 2). In general, the present invention allows a set (e.g. one or more) of visual controls to be inserted into markup that corresponds to web content requested by a user 50. The visual controls are typically inserted into the markup at locations that correspond to a set (e.g., one or more) of data values contained within the markup that are “useable” by multiple portlets of a portal page requested by user 50. Each visual control can be associated with one or more actions that can be taken by user 50. To this extent, a visual control under the present invention can be an icon, button or the like that can be “activated” (e.g., selected) by user 50. Upon activation of a visual control, the one or more actions associated therewith will be displayed/presented to the user 50 for selection. For example, the activation of a visual control could result in a menu or the like being displayed from which user 50 can select an action. It should be understood that single instances of each component are depicted in portal server 34 for clarity purposes only, and that multiple instances of each component could be provided. For example, portal server 34 could include multiple proxy portlets 36 and target portlets 44.

Regardless, the steps of the present invention will be further described in the following illustrative example.

User 50 clicks on a link in source web content 52A (e.g., of a portal page) contributed by web application 46 that was passed through and rewritten by proxy portlet 36. The request is received by portal server 34, which invokes an action on proxy portlet 36. The proxy portlet 36 determines the original URL corresponding to the action and accesses the URL. Pursuant to the request, web application 46 responds to portal server 34 with markup corresponding to the requested web content. Proxy portlet 36 receives the markup and determines whether it is an Extensible Markup Language (XML) format. If not, proxy portlet 36 passed the markup to a converter 38 that converts the markup to a well-formed XML. For example, converter 38 can convert HTML markup to Extensible HTML (XHTML).

In any event, proxy portlet 36 will receive or otherwise access metadata 54 (e.g., configuration information) corresponding to the markup and analyze the same to locate XPATH expressions for the URL it invoked. Proxy portlet 36 will use the XPATH expressions to locate the nodes in the DOM representation of the markup corresponding to data values. Thereafter, proxy portlet 36 will determine the type associated with each data value that is found from the metadata 54. An illustrative depiction of metadata 54 is shown below:

```
<url-property-locators>
  <url-property-locator>
    <url-expression>http://appServer1.myCo.com/app1/
    step1*</url-expression>
    <property-locators>
      <property-locator>
        <property-xpath>//th[@id=‘orders’]//tr/td[1]</property-xpath>
        <insert-control-xpath>//th[@id=‘orders’]//tr/td[1]</
        insert-control-xpath>
        <property-type>orderIdType</property-type>
        <property-namespace>http://www.myCo.com/types</
        property-namespace>
        <property-type-schema-
location>http://www.myCo.com/types/types.xsd</
property-type-schema-location>
      </property-locator>
      <property-locator>
        <property-xpath>//th[@id=‘orders’]//tr/td[2]</property-xpath>
        <insert-control-xpath>//th[@id=‘orders’]//tr/
        td[2]</insert-control-xpath>
        <property-type>customerIdType</property-type>
        <property-namespace>http://www.myCo.com/
        types</property-namespace>
        <property-type-schema-
location>http://www.myCo.com/types/types.xsd</
property-type-schema-location>
      </property-locator>
    </property-locators>
  </url-property-locator>
  <url-property-locator>
    <url-expression>http://appServer1.myCo.com/
    app1/step2*</url-expression>
    <property-locators>
      ...
    </property-locators>
  </url-property-locator>
  ...
</url-property-locators>
```

Under each <property-locators> statement, a location of a data value and a location to insert a corresponding visual control are identified. For example, under the first <property-locators> statement, the following statements are shown:

<property-xpath>//th[@id=‘orders’]//tr/td[1]</property-xpath>
<insert-control-xpath>//th[@id=‘orders’]//tr/td[1]</insert-control-xpath>

The <property-xpath>//th[@id=‘orders’]//tr/td[1]</property-xpath> statement identifies the location of a data value in the web content. Specifically, this statement generally says to look for a “th” element with an identification of “orders.” It further states that to look in a first column to find the data value. The statement <insert-controlx-path>//th[@id=‘orders’]//tr/td[1]</insert-control-xpath> identifies a location to insert a visual control for such data value. Although the location is the same location as the data value in this example, this need not be the case. For example, the visual control could be inserted at a different location of the portal page than the location at which data value is displayed. In any event, proxy portlet 36 will analyze metadata 54 to identify the locations of all such data values and visual control insertion points.

Thereafter, proxy portlet 36 invokes a property broker 40 and passes it the data value and type information. Property broker 40 determines if there are actions implemented by target portlets 44 that can receive the property type. If such actions are found, property broker 40 will generate (additional) markup for the visual controls for displaying the associated actions and invoking them. Proxy portlet 36 will attach/insert the markup to the DOM at the point specified in metadata 54 (at discussed above), which will usually be in close proximity to the point from which the data value was extracted. Proxy portlet 36 will then cache the transformed markup. The steps involving the property broker 40 and insertion/caching of markup for visual controls can be repeated for each data value located in the markup.

At this point, the event phase ends and the render phase begins. The portal's aggregator 42 will collect markup from each proxy portlet 36 on the portal page. To this extent, proxy portlet 36 will return the transformed markup that was previously cached. The portal page is returned to the browser in portal client 32. As shown in the “Browser page 2” state of portal client 32, source content 52B now includes the visual controls 56 as inserted by property broker 40 and/or proxy portlet 36. When user 50 clicks on a visual control 56, he/she will be presented with a list of matching actions. Upon selecting an action, the action is dispatched to target portlet 44 on portal server 34. Target portlet 44 will then perform any necessary processing and updates its state. Thereafter, aggregator 42 once again collects corresponding markup from each proxy portlet 36 in the render phase. At this point, target portlet 44's markup will reflect the results of processing the data value it was passed by portal client, and the corresponding portal page (e.g., source content 52C is returned to the portal client 32).

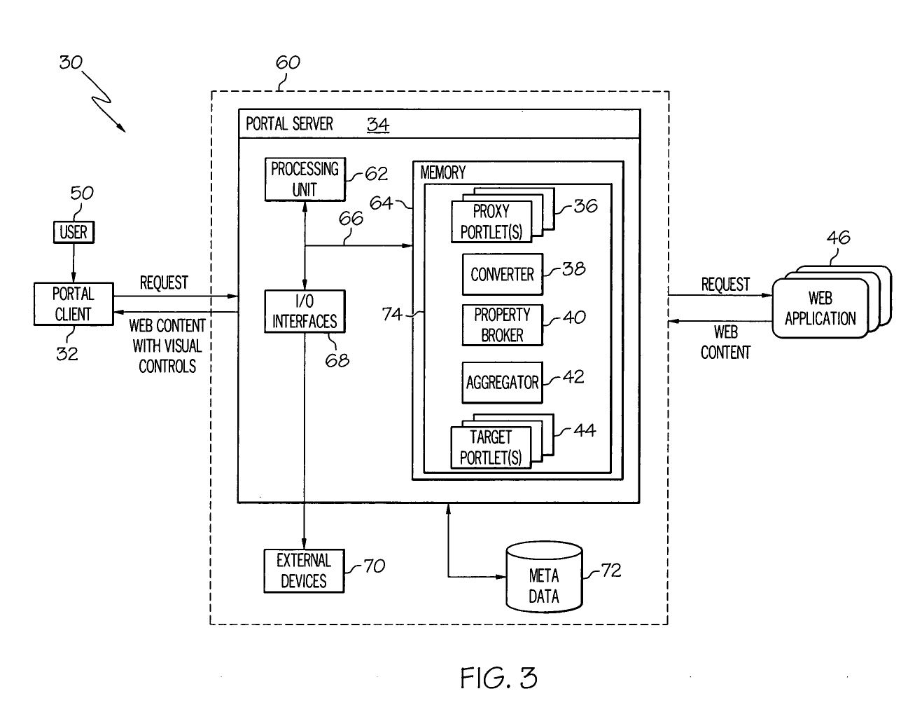

Referring to FIG. 3, a more detailed computerized implementation of the present invention. As depicted, portal server 34 is contained within a computer infrastructure 60 and communicates with portal client 32 and web application(s) 46. Such communication typically occurs over a network (e.g., the Internet, a wide area network (WAN), a local area network (LAN), a virtual private network (VPN), etc. As such, communication can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet.

Portal server 34 is shown within an infrastructure 60 that is separate from web application(s) 46 and portal client 32 to illustrate that the present invention could be carried out by a party who is independent portal client 32 and/or web application 46, such as a service provider or the like, although this need not be the case. In any event, portal server 34 is shown including a processing unit 62, a memory 64, a bus 66, and input/output (I/O) interfaces 68. Further, portal server 34 is shown in communication with external I/O devices/resources 70 and storage system 72. In general, processing unit 62 executes computer program code, such as portal program 74, which is stored in memory 64 and/or storage system 72. While executing computer program code, processing unit 62 can read and/or write data, to/from memory 64, storage system 72, and/or I/O interfaces 68. Bus 66 provides a communication link between each of the components in portal server 34. External devices 70 can comprise any devices (e.g., keyboard, pointing device, display, etc.) that enable a user to interact with portal server 34 and/or any devices (e.g., network card, modem, etc.) that enable portal server 34 to communicate with one or more other computing devices.

Computer infrastructure 60 is only illustrative of various types of computer infrastructures for implementing the invention. For example, in one embodiment, computer infrastructure 60 comprises two or more computing devices (e.g., a server cluster) that communicate over a network to perform the various process steps of the invention. Moreover, portal server 34 is only representative of various possible computer systems that can include numerous combinations of hardware. To this extent, in other embodiments, portal server 34 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 62 may comprise a single processing unit, or be distributed across one or more processing units in one or more locations, e.g., on a client and server. Similarly, memory 64 and/or storage system 72 can comprise any combination of various types of data storage and/or transmission media that reside at one or more physical locations. Further, I/O interfaces 68 can comprise any system for exchanging information with one or more external devices 70. Still further, it is understood that one or more additional components (e.g., system software, math co-processing unit, etc.) not shown in FIG. 1 can be included in portal server 34. However, if portal server 34 comprises a handheld device or the like, it is understood that one or more external devices 70 (e.g., a display) and/or storage system(s) 72 could be contained within portal server 34, not externally as shown.

Storage system 72 can be any type of system (e.g., a database) capable of providing storage for information under the present invention such as metadata corresponding to web/portal content. To this extent, storage system 72 could include one or more storage devices, such as a magnetic disk drive or an optical disk drive. In another embodiment, storage system 72 includes data distributed across, for example, a local area network (LAN), wide area network (WAN) or a storage area network (SAN) (not shown). Although not shown, additional components, such as cache memory, communication systems, system software, etc., may be incorporated into portal server 34. Moreover, although not shown for brevity purposes, portal client 32 and any application servers (not shown) on which web applications 46 are loaded will likely contain computerized components similar to portal server 34.

Shown in memory 64 of portal server 34 is portal program 74 of the present invention. As depicted, portal program 74 includes proxy portlet(s) 36, converter 38, property broker 40, aggregator 42 and target portlet(s) 44. It should be understood that portal program 72 could include other components of known portal programs such as WebSphere Portal Server. Although not shown in FIGS. 2-3, it should be understood that such components could be provided within the scope of the present invention. In any event, the components shown in FIG. 3 perform the functions of the present invention described in conjunction with FIG. 2. Specifically, among other things, portal program 72: receives requests from portal client 32; communicates with web application(s) 46 to receive the requested web content (e.g., markup corresponding thereto); converts the markup to an XML format if necessary; analyzes metadata corresponding to the web content to identify locations of data values and locations to insert visual controls for the data values; generates additional markup for the visual controls and inserts the same into the markup for the requested web content at the identified locations; aggregates the web content into a portal page and serves the same to portal client 32; receives action requests from portal client 32 pursuant to an activation of a visual control and selection of an associated action; analyzes and executes/performs the requested action requests; and returns responses to the portal client 32.

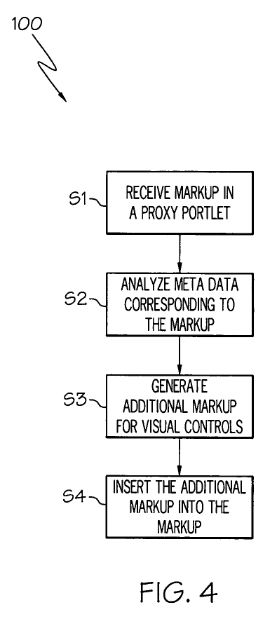

Referring now to FIG. 4, a method flow diagram 100 according to the present invention is shown. First step S1 is to receive markup in a proxy portlet on a portal server from a web application pursuant to a request for web content received in the proxy portlet from a portal client. Second step S2 is to analyze metadata corresponding to the markup to identify a set of data values in the web content that can be used by multiple portlets, and a set of locations in the markup to insert a set of visual controls for the set of data values. In general, each of the set of visual controls can be associated with a set of actions. Third step S3 is to generate additional markup for the set of visual control. Fourth step S4 is to insert the additional markup into the markup at the identified set of locations.

While shown and described herein as a method and system for inserting visual controls into markup for data values in corresponding web content, it is understood that the invention further provides various alternative embodiments. For example, in one embodiment, the invention provides a computer-readable medium that includes computer program code to enable a computer infrastructure to insert visual controls into markup for data values in corresponding web content. To this extent, the computer-readable medium includes program code that implements each of the various process steps of the invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory 64 (FIG. 3) and/or storage system 72 (FIG. 3) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process steps of the invention on a subscription, advertising, and/or fee basis. That is, a service provider, such as a Solution Integrator, could offer to insert visual controls into markup for data values in corresponding web content. In this case, the service provider can create, maintain, support, etc., a computer infrastructure, such as computer infrastructure 60 (FIG. 3) that performs the process steps of the invention for one or more customers. In return, the service provider can receive payment from the customer(s) under a subscription and/or fee agreement and/or the service provider can receive payment from the sale of advertising content to one or more third parties.

In still another embodiment, the invention provides a method for inserting visual controls into markup for data values in corresponding web content. In this case, a computer infrastructure, such as computer infrastructure 60 (FIG. 3), can be provided and one or more systems for performing the process steps of the invention can be obtained (e.g., created, purchased, used, modified, etc.) and deployed to the computer infrastructure. To this extent, the deployment of a system can comprise one or more of (1) installing program code on a computing device, such as portal server 34 (FIG. 3), from a computer-readable medium; (2) adding one or more computing devices to the computer infrastructure; and (3) incorporating and/or modifying one or more existing systems of the computer infrastructure to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A method for inserting visual controls for data values in web content, comprising:
receiving markup pursuant to a request for web content;
analyzing metadata corresponding to the markup to identify a set of data values in the web content and a set of locations in the markup to insert a set of visual controls for the set of data values;
generating additional markup for the set of visual controls; and
inserting the additional markup into the markup at the set of locations identified during the analyzing step.

2. The method of claim 1, wherein each of the set of visuals control is associated with a set of actions, and wherein the set of visuals controls display the associated set of actions upon activation.

3. The method of claim 1, wherein the receiving step comprises receiving markup on a portal server from a web application pursuant to a request for web content previously received on the portal server from a portal client.

4. The method of claim 3, wherein the request for web content and the markup are received in a proxy portlet on the portal server.

5. The method of claim 1, further comprising determining whether a set of actions exist for the set of data values after the analyzing step, wherein the generating step is then performed if the set of actions are determined to exist.

6. The method of claim 1, further comprising converting the markup to Extensible Markup Language (XML) after the receiving step.

7. The method of claim 6, wherein the converting step comprises converting the markup from Hypertext Markup Language (HTML) to Extensible Hypertext Markup Language (XHTML) after to the receiving step.

8. The method of claim 1, wherein the analyzing step comprises locating XML Path Language (XPATH) expressions in the metadata to identify the set of data values and the set of locations.

9. The method of claim 1, further comprising:
receiving an action request pursuant to pursuant to an activation of one of the set of visual controls; and
executing the action request.

10. The method of claim 9, wherein the action request is received in and executed by a target portlet on a portal server.

11. A method for inserting visual controls for data values in web content, comprising:
receiving markup in a proxy portlet on a portal server from a web application pursuant to a request for web content received in the proxy portlet from a portal client;
analyzing metadata corresponding to the markup to identify a set of data values in the web content that can be used by multiple portlets and a set of locations in the markup to insert a set of visual controls for the set of data values, wherein each of the set of visual controls is associated with a set of actions;
generating additional markup for the set of visual controls; and
inserting the additional markup into the markup at the set of locations identified during the analyzing step.

12. The method of claim 11, further comprising:
receiving an action request in a target portlet of the portal server pursuant to an activation of one of the set of visual controls on the portal client; and
executing the action request.

13. A system for inserting visual controls for data values in web content, comprising:
means for receiving markup pursuant to a request for web content;
means for analyzing metadata corresponding to the markup to identify a set of data values in the web content and a set of locations in the markup to insert a set of visual controls for the set of data values;
means for generating additional markup for the set of visual controls; and
means for inserting the additional markup into the markup at the set of locations.

14. The system of claim 13, wherein each of the set of visuals control is associated with a set of actions, and wherein the set of visuals controls display the associated set of actions upon activation.

15. The system of claim 13, wherein the means for receiving comprises a proxy portlet on a portal server, and wherein the markup is received in the proxy portlet from a web application pursuant to a request received in the proxy portlet from a portal client.

16. The system of claim 13, further comprising means for determining whether a set of actions exist for the set of data values after the analyzing step, wherein the additional markup is generated if the set of actions are determined to exist.

17. The system of claim 13, further comprising means for converting the markup to Extensible Markup Language (XML) after the receiving step.

18. The system of claim 17, wherein the markup is converted from Hypertext Markup Language (HTML) to Extensible Hypertext Markup Language (XHTML) after being received.

19. The system of claim 13, wherein the means for analyzing locates Extensible Markup Language Path Language (XPATH) expressions in the metadata to identify the set of data values and the set of locations.

20. The system of claim 13, further comprising:
means for receiving an action request pursuant to an activation of one of the set of visual controls; and
means for executing the action request.

21. The system of claim 20, wherein means for receiving the action request and the means for executing the action request comprise a target portlet on a portal server.

22. A program product stored on a recordable medium for inserting visual controls for data values in web content, the recordable medium comprising program code for performing the following steps:
receiving markup pursuant to a request for web content;
analyzing metadata corresponding to the markup to identify a set of data values in the web content and a set of locations in the markup to insert a set of visual controls for the set of data values;
generating additional markup for the set of visual controls; and
inserting the additional markup into the markup at the set of locations identified during the analyzing step.

23. The program product of claim 22, wherein each of the set of visuals control is associated with a set of actions, and wherein the set of visuals controls display the associated set of actions upon activation.

24. The program product of claim 22, wherein the receiving step comprises receiving markup on a portal server from a web application pursuant to a request for web content previously received on the portal server from a portal client.

25. The program product of claim 24, wherein the request for web content and the markup are received in a proxy portlet on the portal server.

26. The program product of claim 22, the computer readable medium further comprises program code for performing the following step:
determining whether a set of actions exist for the set of data values after the analyzing step, wherein the generating step is then performed if the set of actions are determined to exist.

27. The program product of claim 22, the computer readable medium further comprises program code for performing the following step:
converting the markup to Extensible Markup Language (XML) after the receiving step.

28. The program product of claim 27, wherein the converting step comprises converting the markup from Hypertext Markup Language (HTML) to Extensible Hypertext Markup Language (XHTML) after to the receiving step.

29. The program product of claim 22, wherein the analyzing step comprises locating Extensible Markup Language Path Language (XPATH) expressions in the metadata to identify the set of data values and the set of locations.

30. The program product of claim 22, the computer readable medium further comprises program code for performing the following steps:
receiving an action request pursuant to an activation of one of the set of visual controls; and
executing the action request.

31. The program product of claim 30, wherein the action request is received in and executed by a target portlet on a portal server.

32. A method for deploying an application for inserting visual controls for data values in web content, comprising:
providing a computer infrastructure being operable to:
receive markup pursuant to a request for web content;
analyze metadata corresponding to the markup to identify a set of data values in the web content and a set of locations in the markup to insert a set of visual controls for the set of data values;
generate additional markup for the set of visual controls; and
insert the additional markup into the markup at the set of locations.

33. Computer software embodied as a propagated signal for inserting visual controls for data values in web content, the computer software comprising instructions to enable a computer system to perform the following functions:
receive markup pursuant to a request for web content;
analyze metadata corresponding to the markup to identify a set of data values in the web content and a set of locations in the markup to insert a set of visual controls for the set of data values;
generate additional markup for the set of visual controls; and
insert the additional markup into the markup at the set of locations.
